(19) United States
(12) Patent Application Publication
(10) Pub. No.: US 2007/0242816 A1
(43) Pub. Date: Oct. 18, 2007

(54) CONVERGED PREPAID AND POSTPAID CHARGING

(76) Inventors: Yigang Cai, Naperville, IL (US); Xiangyang Li, Beijing (CN); Shuo Lv, Beijing (CN); Peng Wang, Beijing (CN); Xiao Tang Wang, Beijing (CN); Wan Bin Yan, Beijing (CN); Jay Z. Zhao, Beijing (CN)

Correspondence Address: DUFT BORNSEN & FISHMAN, LLP, 1526 SPRUCE STREET, SUITE 302, BOULDER, CO, 80302, US

(21) Appl. No.: 11/563,560

(22) Filed: Nov. 27, 2006

(30) Foreign Application Priority Data
Apr. 14, 2006 (CN) 200610099632.3

(51) Int. Cl. H04M 15/00

(52) U.S. Cl. 379/127.05

(57) ABSTRACT

Communication networks and methods are disclosed for providing converged prepaid charging and postpaid charging. A communication network described herein includes a switching system, a charging selection system, a prepaid charging system, and a postpaid charging system. When the switching system receives a call for a subscriber, the switching system processes a subscriber profile to determine a type of charging for the call. If the type of charging for the subscriber comprises a hybrid prepaid/postpaid charging, then the switching system transmits a query to the charging selection system. Responsive to the query, the charging selection system processes charging criteria to determine whether the hybrid prepaid/postpaid charging for the call should be prepaid or postpaid. The charging selection system initiates prepaid charging or postpaid charging for the call based on the charging criteria.

### RELATED APPLICATIONS

This patent application claims priority to a foreign patent application filed in the Chinese Patent Office, having the application number 200610099632.3 and filed on Apr. 14, 2006.

### BACKGROUND OF THE INVENTION

1. Field of the Invention

The invention is related to the field of communications, and in particular, to converging prepaid charging and postpaid charging in communication networks.

2. Statement of the Problem

Charging in wireless and wireline networks has traditionally been either postpaid or prepaid. Prepaid charging refers to the type of charging where a subscriber purchases the service prior to use and the balance paid for by the subscriber is decremented based on the usage by the subscriber. As an example, a subscriber may purchase ten hours of airtime in a prepaid wireless plan. As the subscriber places or receives calls over the wireless network, IN-based technology in the network real-time monitors the usage by the subscriber and decrements the account of the subscriber accordingly. If the subscriber's account runs low or runs out, then the subscriber needs to recharge the account before further usage will be granted by the network.

Postpaid charging refers to the type of charging where a subscriber uses a service prior to paying for the service. As an example, a subscriber may enter into a contract with a service provider specifying what the subscriber will be billed for the service. As the subscriber places or receives calls over the network, IT-based technology collects call information during the call and generates a call detail record (CDR) for the call. The CDR includes information such as the calling party, the called party, the duration of call, etc. The CDRs are collected by a billing system of the service provider that aggregates the CDRs for a billing cycle. At the end of the billing cycle, the service provider sends out a bill to the subscriber that specifies the usage by the subscriber during the billing cycle.

One present problem with charging systems hi communication networks is that a subscriber needs to either sign up for prepaid charging or postpaid charging. The prepaid charging system and the postpaid charging system are operated separately by most if not all service providers. A subscriber thus does not have the option to sign up for both prepaid charging and postpaid charging with the same service provider.

FIG. 1 illustrates a communication network 100 in the prior art. Communication network 100 includes a core network 102, such as a wireline network or a wireless network. Communication network 100 also includes a prepaid charging system 110, a mediation system 120, a postpaid charging system 130, and a billing system 140. Prepaid charging system 110 provides prepaid charging mechanisms for subscribers. Prepaid charging system 110 includes a real-time call control system 112, an account balance management system 114, and a real-time rating and billing engine 116. Real-time call control system 112 provides budget control for prepaid calls. For instance, call control system 112 may identify a balance from account balance management system 114 and authorize a prepaid call if the balance is sufficient. Call control system 112 may also authorize or grant a quota (slice) for a prepaid call to the core network 102, provide announcements to subscribers, and terminate a call if the balance runs out. Account balance management system 114 provides account management, such as to monitor the balance of a subscriber, determine when the account is below a threshold, provide a mechanism to recharge the account via a credit card or other means, etc. Real-time rating and billing engine 116 determines a rating for a prepaid call. To provide the rating, rating and billing engine 116 receives call information from call control system 112 and account information from account balance management system 114, and generates a rating for the prepaid call (e.g., 5¢ a minute). After a prepaid call has ended, call control system 112 generates a rated prepaid CDR and transmits the rated prepaid CDR to billing system 140.

Mediation system 120 is configured to receive, process, and reformat usage information to a suitable format for processing by postpaid charging system 130 or billing system 140. If mediation system 120 receives an unrated postpaid CDR for a call from core network 102, then mediation system 120 may reformat the unrated postpaid CDR according to the desired format of postpaid charging system 130 or billing system 140. If mediation system 120 receives multiple unrated postpaid CDRs for a call from the elements in core network 102, such as for a 9-1-1 call or a multi-party call, then mediation system 120 combines the multiple CDRs into a single unrated CDR as preferred by postpaid charging system 130 or billing system 140. Mediation system 120 may be implemented in billing system 140, may be implemented in postpaid charging system 130, or may be a stand-alone system as shown in FIG. 1.

Postpaid charging system 130 provides postpaid charging mechanisms for subscribers. Postpaid charging system 130 includes a batch rating engine 132. Similar to prepaid charging system 110, batch rating engine 132 determines a rating for postpaid calls. To provide the rating, batch rating engine 132 receives an unrated postpaid CDR from mediation system 120. Batch rating engine 132 then determines a rating for the CDR and generates a rated postpaid CDR to transmit to the billing system 140.

Billing system 140 is configured to receive rated prepaid CDRs from prepaid charging system 110 and rated postpaid CDRs from postpaid charging system 130. Billing system 140 uses the CDRs to generate bills, generate usage reports, perform service management and payment management, and perform any other billing functions.

Unfortunately, prepaid charging system 110 and postpaid charging system 130 operate separately from one another. A subscriber can only subscribe to prepaid charging or prepaid charging with the service provider, but not both.

### SUMMARY OF THE SOLUTION

The invention solves the above and other related problems by converging prepaid charging and postpaid charging in a communication network. A subscriber may subscribe to prepaid charging, postpaid charging, or a hybrid prepaid/postpaid charging. With the hybrid charging, a subscriber may be charged prepaid or postpaid depending on charging criteria defined by the subscriber, defined by the service provider, or defined by another party. As an example, the charging criteria may be a time of day. A company may pay for a subscriber's calls during the work day (8 pm to 5 pm), which are charged to the company postpaid. After the work day, the subscriber may be responsible for the calls, which are charged to a prepaid account of the subscriber. The converged prepaid and postpaid charging advantageously allows for different charging for a subscriber based on the charging criteria, which provides more flexibility to the subscriber and may expand the market of subscribers.

One embodiment of the invention comprises an enhanced communication network that provides converged prepaid charging and postpaid charging. The communication network includes a switching system, a charging selection system, a prepaid charging system, and a postpaid charging system. When in operation, the switching system receives a call for a subscriber. Responsive to the call, the switching system processes a subscriber profile to determine a type of charging for the call. If the type of charging for the subscriber comprises a hybrid prepaid/postpaid charging, then the switching system transmits a query to the charging selection system. The charging selection system receives the query for the call and processes charging criteria to determine whether the hybrid prepaid/postpaid charging for the call should be prepaid or postpaid. The charging criteria may be previously defined by the subscriber, defined by the service provider, or defined by another party. Examples of charging criteria include but are not limited to a time of day, a day of the week, a location of the subscriber, a destination for the call, an instruction from the subscriber, the type of call, the type of content for the call, a balance threshold for the subscriber, etc. If the charging selection system determines that the charging for the call should be prepaid based on the charging criteria, then the charging selection system initiates prepaid charging for the call, such as in the prepaid charging system. If the charging selection system determines that the charging for the call should be postpaid based on the charging criteria, then the charging selection system initiates postpaid charging for the call, such as in the postpaid charging system.

The invention may include other exemplary embodiments described below.

### DESCRIPTION OF THE DRAWINGS

FIG. 1 illustrates a communication network in the prior art.

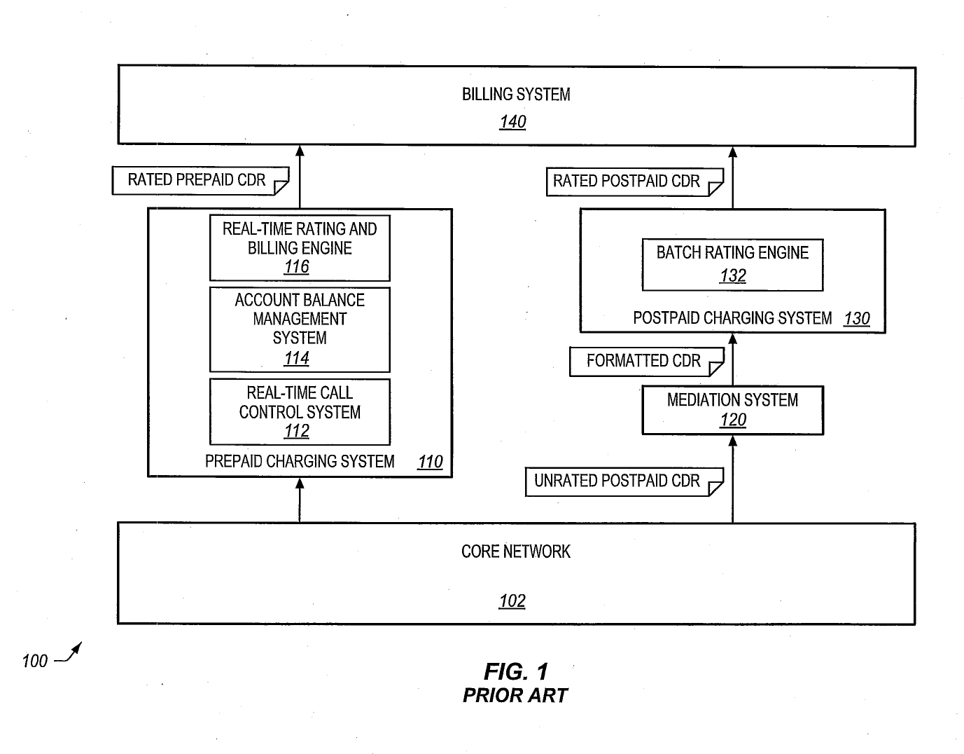

FIG. 2 illustrates a communication network in an exemplary embodiment of the invention.

FIG. 3 is a flow chart illustrating a method of operating a switching system in an exemplary embodiment of the invention.

FIG. 4 is a flow chart illustrating a method of operating a charging selection system in an exemplary embodiment of the invention.

FIG. 5 illustrates another communication network in an exemplary embodiment of the invention.

FIG. 6 is a block diagram further illustrating how a charging selection system operates in an exemplary embodiment of the invention.

FIG. 7 illustrates another communication network in an exemplary embodiment of the invention.

### DETAILED DESCRIPTION OF THE INVENTION

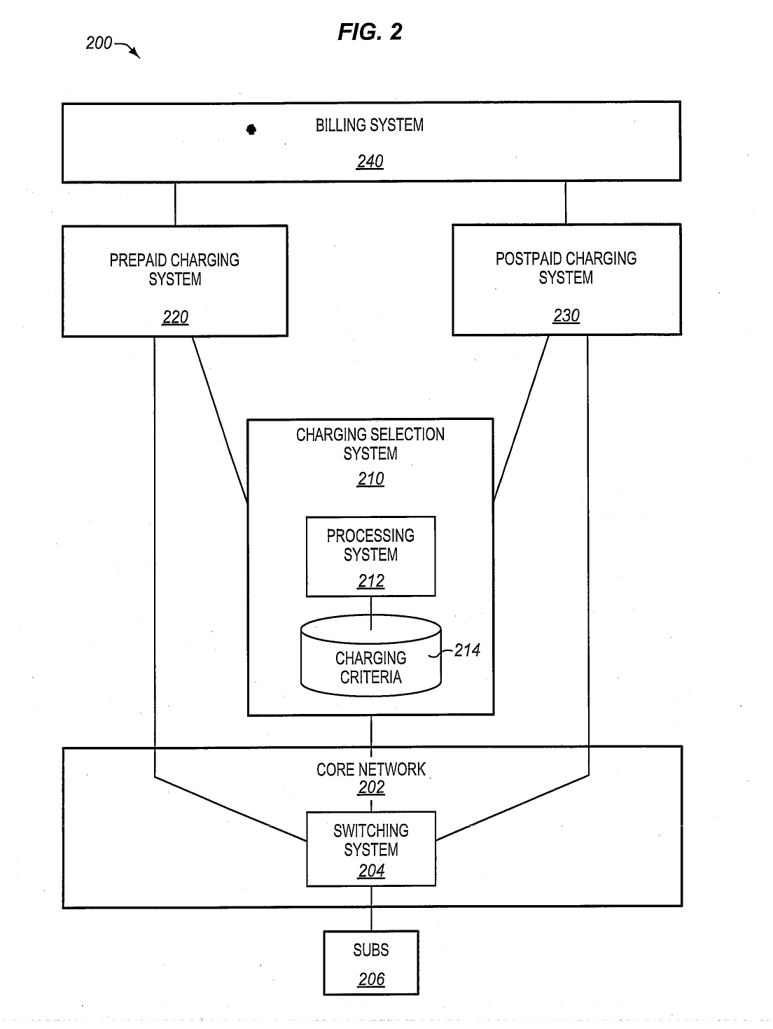

FIGS. 2-7 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 2 illustrates a communication network 200 in an exemplary embodiment of the invention. Communication network 200 includes a core network 202 that is illustrated as including a switching system 204. Core network 202 may comprise a wireline network, a wireless network, an IMS network, or another type of network. Switching system 204 comprises any system or server adapted to serve subscriber 206 to connect calls to or receive calls from subscriber 206. Examples of switching system 204 include a switch, a Mobile Switching Center (MSC), a Call Serving Control Function (CSCF), or another type of element depending on the type of core network 202.

Communication network 200 also includes a charging selection system 210 coupled to core network 202. Charging selection system 210 includes a processing system 212 and a database 214. Database 214 stores charging criteria for calls in core network 202. Charging criteria comprises any definitions, policy rules, or other data used to determine whether a call in core network 202 should be charged as prepaid or charged as postpaid. The charging criteria may be defined by subscriber 206, by the service provider operating the core network 202, or another party or entity. Examples of charging criteria are provided later in this description. Charging criteria may be stored in other elements (not shown) distributed in communication network 200 that is accessible to charging selection system 210.

Communication network 200 also includes a prepaid charging system 220, a postpaid charging system 230, and a billing system 240. Prepaid charging system 220 may comprise a traditional or enhanced system adapted to provide prepaid charging for calls in core network 202. Postpaid charging system 230 may comprise a traditional or enhanced system adapted to provide postpaid charging for calls in core network 202. Billing system 240 comprises any traditional or enhanced system that handles billing for calls in core network 202 responsive to receiving information (e.g., CDRs) from either prepaid charging system 220 or postpaid charging system 230.

In one embodiment, charging selection system 210 may be implemented in prepaid charging system 220. In another embodiment, charging selection system 210 may be implemented in postpaid charging system 230. In another embodiment, charging selection system 210 may be implemented in a stand-alone system or server as illustrated in FIG. 2 or in an element of core network 202, such as a switch. Charging selection system 210 may be implemented as software, hardware, or a combination of hardware and software. In a software implementation, charging selection system 210 may be comprised of instructions that are stored on storage media. The instructions may be retrieved and executed by processing system 212. Some examples of instructions are software, program code, and firmware. Some examples of storage media are memory devices, tape, disks, integrated circuits, and servers. The instructions are operational when executed by processing system 212 to direct processing system 212 to operate in accordance with the invention. The term “processing system” refers to a single processing device or a group of inter-operational processing devices. Some examples of processors are computers, integrated circuits, and logic circuitry. Those skilled in the art are familiar with instructions, processors, and storage media.

Communication network 200 is enhanced to allow subscriber 206 to subscribe to both prepaid charging and postpaid charging as offered by the service provider. Other subscribers (not shown) may subscribe to prepaid charging only, and communication network 200 may operate in a conventional manner to provide prepaid charging to those subscribers. Other subscribers (not shown) may alternatively subscribe to postpaid charging only, and communication network 200 may operate in a conventional manner to provide postpaid charging to those subscribers. In this embodiment, subscriber 206 has subscribed to both prepaid charging and postpaid charging, which is referred to herein as hybrid charging.

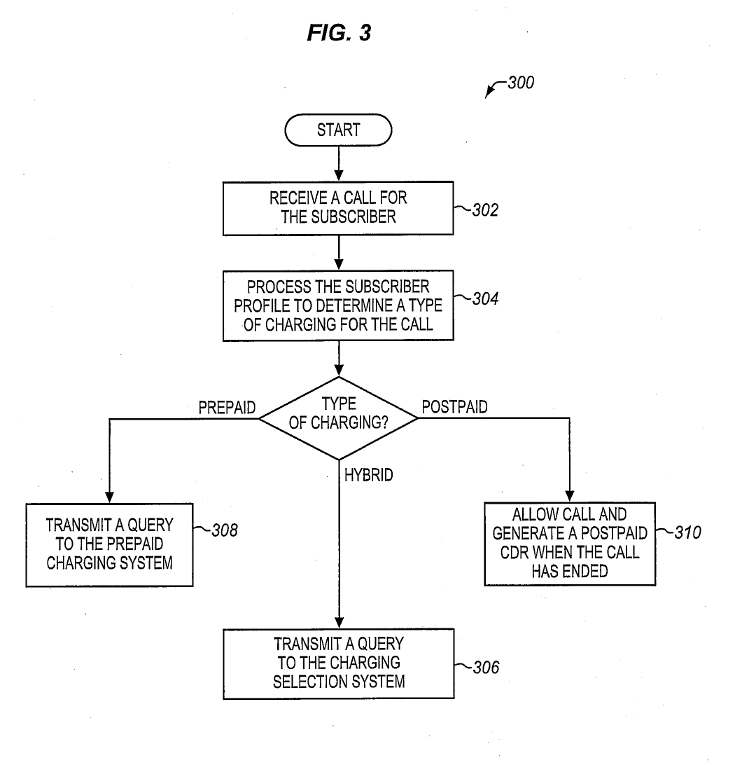

If subscriber 206 initiates a call in core network 202 or receives a call from core network 202, then switching system 204 receives the call. The ten “call” as used herein may refer to a voice call, a data call, an SMS/MMS message, an IMS session (for voice, multimedia, gaming, etc), or another type of communication for subscriber 206. Switching system 204 may operate as described in FIG. 3 responsive to receiving the call.

FIG. 3 is a flow chart illustrating a method 300 of operating switching system 204 in an exemplary embodiment of the invention. The steps of method 300 will be described with reference to switching system 204 shown in FIG. 2. The steps of the flow chart in FIG. 3 are not all inclusive and may include other steps not shown.

In step 302, switching system 204 receives a call for subscriber 206. As previously stated, the call may be initiated by subscriber 206 or destined for subscriber 206. In step 304, switching system 204 processes a subscriber profile for subscriber 206 to determine a type of charging for the call. The type of charging may be prepaid charging, postpaid charging, or hybrid charging. Switching system 204 may locally store the subscriber profile, or may access another device, such as a Home Location Register (HLR) or a Home Subscriber Server (HSS), to retrieve the subscriber profile. The subscriber profile indicates the class of service subscribed to by subscriber 206. In this embodiment, subscriber 206 has subscribed to a class of service that allows for hybrid charging.

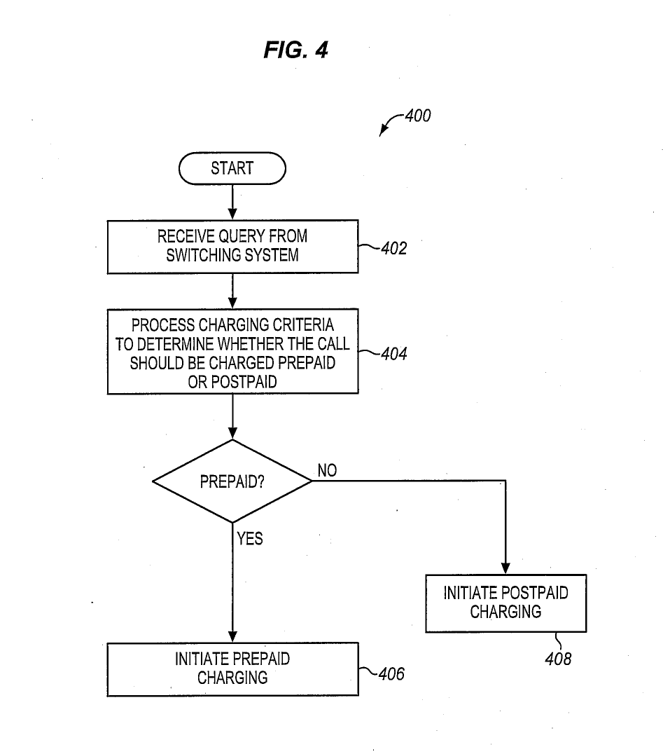

If the charging type is determined to be hybrid charging, then switching system 204 generates a query for how to proceed with the call, and transmits the query to charging selection system 210 in step 306. An exemplary operation of charging selection system 210 responsive to the query is described in FIG. 4.

If the charging type is determined to be prepaid charging, then switching system 204 generates a query and transmits the query to prepaid charging system 220 in step 308 in a conventional manner. The purpose of the query is traditionally to ask prepaid charging system 220 whether subscriber 206 is allowed to place or receive this call. For instance, subscriber 206 may have a low balance or an empty balance in his/her account which causes prepaid charging system 220 to instruct switching system 204 to deny the call unless subscriber 206 recharges the account. The format of the query in step 306 or 308 depends on the type of core network 202. The format may be CS-1 for wireline networks, CAP for GSM networks, IS-826 for CDMA networks, or Diameter for IMS networks.

If the charging type is determined to be postpaid charging, then switching system 204 allows the call to be completed, and generates an unrated postpaid CDR in step 310 when the call has ended in a conventional manner.

FIG. 4 is a flow chart illustrating a method 400 of operating charging selection system 210 in an exemplary embodiment of the invention. The steps of method 400 will be described with reference to charging selection system 210 shown in FIG. 2. The steps of the flow chart in FIG. 4 are not all inclusive and may include other steps not shown. In step 402, processing system 212 in charging selection system 210 receives the query for the call from switching system 204. In step 404, processing system 212 processes the charging criteria stored in database 214 to determine whether the call should be charged prepaid or postpaid. If processing system 212 determines that the charging for the call should be prepaid based on the charging criteria, then charging selection system 210 initiates prepaid charging for the call in step 406. Initiating the prepaid charging may comprise transmitting an instruction, query, or another message to an element (not shown) in prepaid charging system 220, such as a real-time call control system or a real-time rating and billing engine. Prepaid charging system 220 then determines a rating for the call, and grants a quota to switching system 204 based on the rating. If prepaid charging system 220 subsequently receives an indication that the call has ended from switching system 204, then prepaid charging system 220 generates a rated prepaid CDR after the call ends, and stores the rated prepaid CDR. The rated prepaid CDR may subsequently be retrieved by billing system 240.

If processing system 212 determines that the charging for the call should be postpaid based on the charging criteria, then processing system 212 initiates postpaid charging for the call in step 408. Initiating the postpaid charging may comprise transmitting an instruction or another message to switching system 204 instructing switching system 204 to allow the call to be completed. When the call subsequently ends, different operations may take place. Switching system 204 may generate an unrated postpaid CDR after the call ends, and transmit the unrated postpaid CDR to postpaid charging system 230. Switching system 204 may alternatively transmit an indication to prepaid charging system 220 that the call has ended. Responsive to receiving the indication, prepaid charging system 220 generates an unrated postpaid CDR after the call ends, and stores the unrated postpaid CDR. Postpaid charging system 220 then retrieves the unrated postpaid CDR, determines a rating for the call, and generates a rated postpaid CDR from the unrated postpaid CDR. The rated postpaid CDR may subsequently be retrieved by billing system 240.

Charging selection system 210 advantageously allows-subscriber 206 to receive prepaid charging or postpaid charging depending on the charging criteria. The charging criteria may be specified by subscriber 206, the service provider operating communication network 200, or another party. Defining the charging criteria advantageously allows subscriber 206 and/or the service provider to flexibly define when a call for subscriber 206 is charged prepaid and when a call is charged postpaid.

One example of charging criteria may be the time of day. Subscriber 206 may receive prepaid charging during certain times of the day, and may receive postpaid charging during other times of the day. For instance, during the work day (8 am to 5 pm) subscriber 206 may be charged postpaid (which may be paid by the employer), and after the work day subscriber 206 may be charged prepaid to his own prepaid account.

Another example of charging criteria may be the day of the week. As an example, subscriber 206 may be charged postpaid during the week days (Monday through Friday), and may be charging prepaid during the weekend.

Another example of charging criteria may be the location of the subscriber 206. As an example, if subscriber 206 is roaming outside of a particular service area, then subscriber 206 may be charged prepaid. If subscriber 206 is located in a home service area, then subscriber 206 may be charged postpaid.

Another example of charging criteria may be the destination of the call. As an example, if the destination of the call is an international number, then subscriber 206 may be charged prepaid. If the destination of the call is a national number, then subscriber 206 may be charged postpaid.

Another example of charging criteria may be an instruction provided by subscriber 206 indicating the type of charging desired for the call. The instruction may be a feature code, a prefix number, or some other indication. As an example, subscriber 206 may add the prefix number “2” before the called party number to have the call charged prepaid. Subscriber 206 may add the prefix number “3” before the called party number to have the call charged postpaid.

Another example of charging criteria may be the type of call, such as voice, video, SMS, MMS, gaming, etc. As an example, voice calls for subscriber 206 may be charged postpaid, while SMS calls or data calls may be charged prepaid.

Another example of charging criteria may be the type of content for the call. As an example, a call providing weather information to subscriber 206 may be charged postpaid, while calls for mobile gaming or mobile commerce services may be charged prepaid.

Another example of charging criteria may be a balance threshold for an account for subscriber 206. As an example, when subscriber 206 uses up the prepaid balance to a defined threshold, the call may be charged postpaid. Or vice-versa, when postpaid monthly anytime minutes are used up in a wireless subscription, the charging may change to a prepaid account to avoid the higher charging rate for over-usage.

Any of the above and other charging criteria may be combined for hybrid charging subscribers so that the subscribers may be charged prepaid or postpaid as desired.

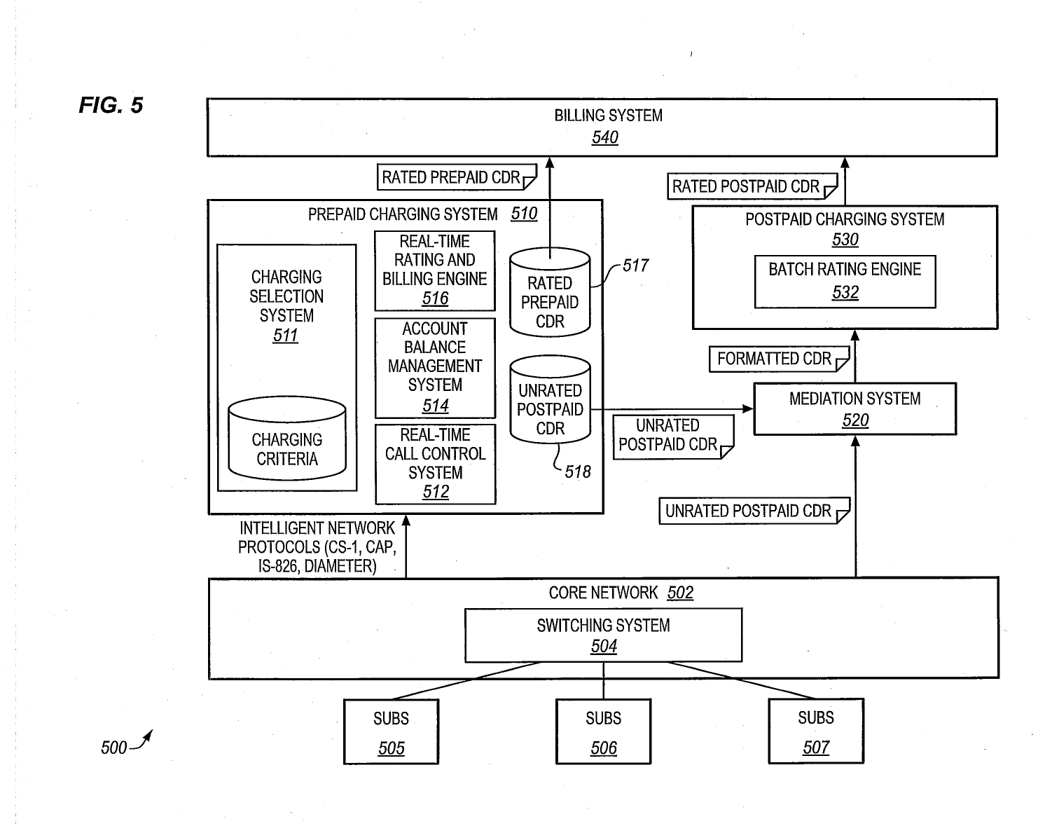

FIG. 5 illustrates a communication network 500 in an exemplary embodiment of the invention. Communication network 500 includes a core network 502, such as a wireline network, a wireless network, or an IMS network. Core network 502 includes a switching system 504. Communication network 500 also includes a prepaid charging system 510, a mediation system 520, a postpaid charging system 530, and a billing system 540. In this embodiment, prepaid charging system 510 is enhanced by including charging selection system 511. Prepaid charging system 510 further includes a real-time call control system 512, an account balance management system 514, and a real-time rating and billing engine 516. Postpaid charging system 530 includes a batch rating engine 532.

Core network 502 and switching system 504 are illustrated as serving three subscribers 505-507. Subscriber 505 has subscribed to prepaid charging, subscriber 506 has subscribed to hybrid charging, and subscriber 507 has subscribed to postpaid charging.

Assume for this embodiment that subscriber 505 places a call in core network 502. Switching system 504 receives the call from subscriber 505 and then identifies a subscriber profile for subscriber 505. The subscriber profile indicates the class of service for subscriber 505, which indicates prepaid charging in this embodiment. Based on the identified prepaid charging for subscriber 505, switching system 504 transmits a query to prepaid charging system 510 on how to proceed for the call.

Real-time call control system 512 receives the query from switching system 504. Real-time call control system 512 accesses account balance management system 514 to determine a present balance for subscriber 505. If the present balance is over a threshold, then call control system 512 contacts real-time rating and billing engine 516 for a rating for the call. Rating and billing engine 516 determines a rating for the call based on call information, account information, and other information, and transmits the rating to call control system 512. Call control system 512 then determines a quota (or slice) to grant for the call, and transmits a response message to switching system 504 with the quota for the call. Switching system 504 then completes the call and monitors the granted quota during the call. If the granted quota is used up, then switching system 504 queries call control system 512 for another quota.

When the call ends, rating and billing engine 516 rates the call according to the actual call duration for the call. Call control system 512 then generates a rated prepaid CDR and stores the rated prepaid CDR in a depository 517 for billing system 540. Billing system 540 will access the rated prepaid CDR for further processing, such as report analysis, resettlement, etc.

Further assume for this embodiment that subscriber 507 places a call in core network 502. Switching system 504 receives the call from subscriber 507 and then identifies a subscriber profile for subscriber 507. The subscriber profile indicates the class of service for subscriber 507, which indicates postpaid charging in this embodiment. Based on the identified postpaid charging for subscriber 507, switching system 504 allows the call to be completed, and then generates an unrated postpaid CDR when the call has ended. Switching system 504 transmits the unrated postpaid CDR to mediation system 520. Mediation system 520 reformats the unrated postpaid CDR (if needed), and transmits the unrated postpaid CDR to postpaid charging system 530. The batch rating engine 532 determines a rating for the call represented by the unrated postpaid CDR, and generates a rated postpaid CDR. Postpaid charging system 530 then transmits the rated postpaid CDR to billing system 540 for further processing.

Further assume for this embodiment that subscriber 506 places a call in core network 502. Switching system 504 receives the call from subscriber 506 and then identifies a subscriber profile for subscriber 506. The subscriber profile indicates the class of service for subscriber 506, which indicates hybrid charging in this embodiment. Based on the identified hybrid charging for subscriber 506, switching system 504 transmits a query to prepaid charging system 510 on how to proceed for the call. Switching system 504 is provisioned to route hybrid charging calls to prepaid charging system 510 via intelligent network protocol according to a charging address provisioned in the subscriber profile.

Charging selection system 511 receives the query from switching system 504. The function of charging selection system 511 is to determine whether the call is to be charged prepaid or postpaid based on the charging criteria. Responsive to receiving the query, charging selection system 511 processes the charging criteria to determine the proper charging for the call.

If charging selection system 511 determines that the charging is prepaid, then charging selection system 511 transmits an instruction or another message to call control system 512 to handle prepaid charging for the call. Call control system 512 contacts account balance management system 514 to determine a present balance for subscriber 506. If the present balance is over a threshold, then call control system 512 contacts rating and billing engine 516 for a rating for the call. Rating and billing engine 516 determines a rating for the call based on call information, account information, and other information, and transmits the rating to call control system 512. Call control system 512 then determines a quota (or slice) to grant for the call, and transmits a response message to switching system 504 with the quota for the call. Switching system 504 then completes the call and monitors the granted quota during the call. If the granted quota is used up, then switching system 504 queries call control system 512 for another quota.

When the call ends, rating and billing engine 516 rates the call according to the actual call duration for the call. Call control system 512 then generates a rated prepaid CDR and stores the rated prepaid CDR in depository 517 for billing system 540 for further processing.

If charging selection system 511 determines that the charging is postpaid for this call, then charging selection system 511 responds to switching system 504 to allow the call. No rating is needed at this point for the postpaid charging. Charging selection system 511 may instruct switching system 504 to report a postpaid CDR to postpaid charging system 530 after the call has ended. Alternatively, charging selection system 511 may instruct switching system 504 to report to call control system 512 when the call has ended. If call control system 512 receives an indication that the call has ended, then call control system 512 generates an unrated postpaid CDR and stores the unrated postpaid CDR in a depository 518. The unrated postpaid CDR will then be pulled by or pushed to mediation device 520. The unrated postpaid CDR will then go through the normal postpaid rating process, such as CDR formatting in mediation device 520, batch rating and billing in postpaid charging system 530, etc. After the postpaid CDR is rated, postpaid charging system 530 delivers the rated postpaid CDR to billing system 540 for further processing.

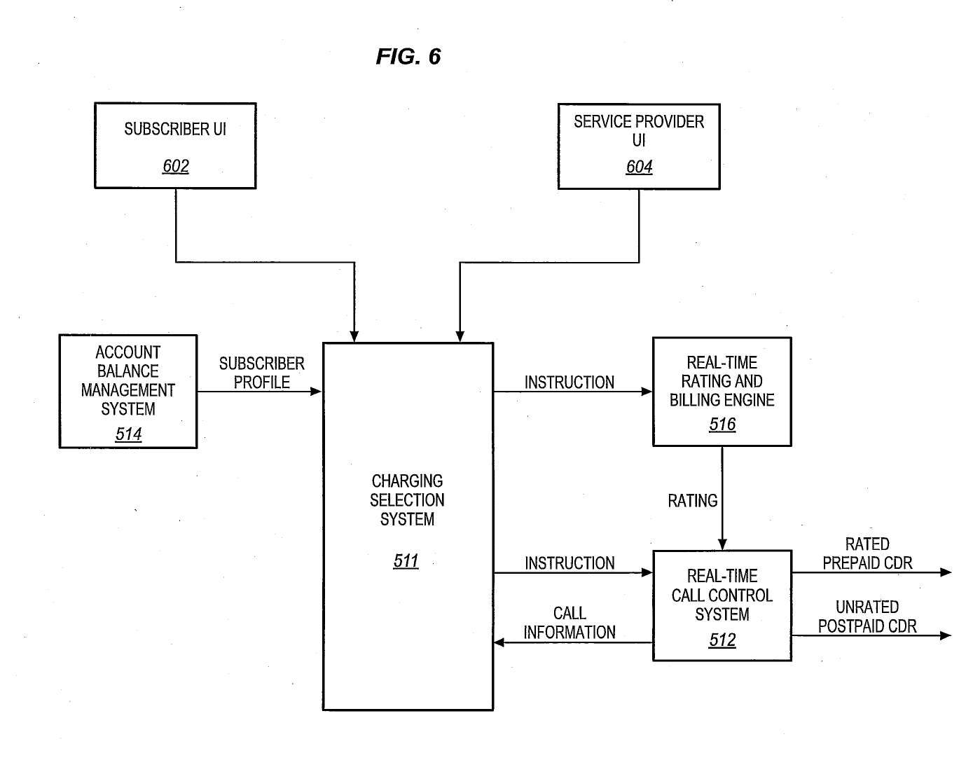

FIG. 6 is a block diagram further illustrating how charging selection system 511 operates in an exemplary embodiment of the invention. Charging selection system 511 allows subscriber 506 to define some or all of the charging criteria through a subscriber user interface (UI) 602. The subscriber UI 602 may comprise a web portal accessible through a computer, a wireless interface accessible through a mobile device through WAP or another protocol, an interactive voice response (IVR) interface or similar interface, etc. Charging selection system 511 also allows the service provider to define some or all of the charging criteria through a service provider UI 604.

When the charging criteria are defined, charging selection system 511 stores the charging criteria. When a hybrid charging call is subsequently received in the core network 502 and switching system 504 transmits a query to charging selection system 511, charging selection system 511 may operate as follows. Charging selection system 511 receives a subscriber profile for subscriber 506 from account balance management system 514. Charging selection system 511 also receives call information from call control system 512. Charging selection system 511 processes the subscriber profile, the call information, and the charging criteria to determine whether charging for the call should be prepaid or postpaid. If the determination is prepaid, then charging selection system 511 transmits an instruction or message to rating and billing engine 516. Rating and billing engine 516 determines a rating for the call, and provides the rating to call control system 512. Call control system 512 then generates a rated prepaid CDR. If the determination is postpaid, then charging selection system 511 transmits an instruction or message to call control system 512. Call control system 512 generates an unrated postpaid CDR.

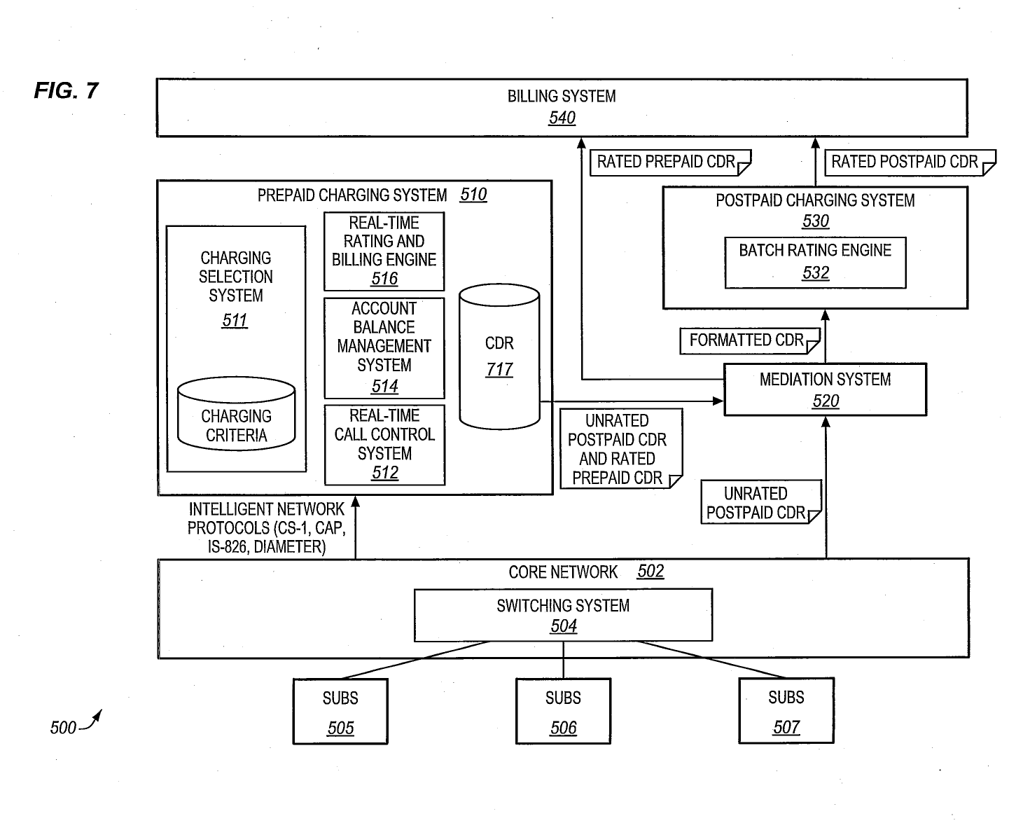

FIG. 7 illustrates another exemplary embodiment of communication network 500. In this embodiment, prepaid charging system 510 has a common depository 717 for rated prepaid CDRs and unrated postpaid CDRs. In this embodiment, all of the CDRs (prepaid or postpaid) are ported to mediation system 520 for CDR filtering. If a CDR is prepaid, then meditation system 520 directly routes the rated prepaid CDR to billing system 540 for further processing. If a CDR is postpaid, then mediation system 520 formats the CDR and transmits the postpaid CDR to batch rating engine 532 for batch processing. When the unrated postpaid CDR is rated, batch rating engine 532 transmits the rated postpaid CDR to billing system 540 for farther processing.

Although specific embodiments were described herein, the scope of the invention is not limited to those specific embodiments. The scope of the invention is defined by the following claims and any equivalents thereof.

We claim:

1. A communication network adapted to provide converged prepaid charging and postpaid charging for a subscriber, the communication network comprising:
a prepaid charging system;
a postpaid charging system;
a charging selection system; and
a switching system adapted to receive a call for a subscriber, process a subscriber profile for the subscriber to determine a type of charging for the call, and transmit a query to the charging selection system responsive to a determination that the charging type comprises a hybrid prepaid/postpaid charging;
the charging selection system adapted to receive the query for the call from the switching system, process charging criteria to determine whether the hybrid prepaid/postpaid charging for the call should be prepaid or postpaid, initiate prepaid charging for the call responsive to a determination of prepaid charging for the call based on the charging criteria, and initiate postpaid charging for the call responsive to a determination of postpaid charging for the call based on the charging criteria.

2. The communication network of claim 1 wherein the charging criteria is predefined by at least one of the subscriber or a service provider operating the communication network.

3. The communication network of claim 1 wherein the charging criteria comprises at least one of time of day, day of week, location of the subscriber, destination of the call, instructions from the subscriber, call type, content type, or balance threshold.

4. The communication network of claim 1 wherein if a determination of prepaid charging is made in the charging selection system, then the prepaid charging system is adapted to:
determine a rating for the call; and
grant a quota for the call to the switching system based on the rating.

5. The communication network of claim 4 wherein the prepaid charging system is further adapted to:
receive an indication that the call has ended from the switching system;
generate a rated prepaid CDR after the call ends; and
store the rated prepaid CDR.

6. The communication network of claim 1 wherein if a determination of postpaid charging is made in the charging selection system, then the prepaid charging system is adapted to:
allow the call to be completed by the switching system.

7. The communication network of claim 6 wherein the prepaid charging system is further adapted to:
receive an indication that the call has ended from the switching system;
generate an unrated postpaid CDR after the call ends; and
store the unrated postpaid CDR.

8. The communication network of claim 7 wherein the postpaid charging system is adapted to:
retrieve the unrated postpaid CDR from the prepaid charging system;
determine a rating for the call; and
generate a rated postpaid CDR from the unrated postpaid CDR.

9. The communication network of claim 1 wherein the charging selection system is implemented in the prepaid charging system.

10. A method of providing converged prepaid charging and postpaid charging for a subscriber, the method comprising:
receiving a call for a subscriber in a communication network; and
processing a subscriber profile for the subscriber to determine a type of charging for the call;
if the charging type comprises a hybrid prepaid/postpaid charging, then the method further includes:
processing charging criteria to determine whether the hybrid prepaid/postpaid charging for the call should be prepaid or postpaid;
initiating prepaid charging for the call responsive to a determination of prepaid charging for the call based on the charging criteria; and
initiating postpaid charging for the call responsive to a determination of postpaid charging for the call based on the charging criteria.

11. The method of claim 10 wherein the charging criteria is predefined by at least one of the subscriber or a service provider operating the communication network.

12. The method of claim 10 wherein the charging criteria comprises at least one of time of day, day of week, location of the subscriber, destination of the call, instructions from the subscriber, call type, content type, or balance threshold.

13. The method of claim 10 wherein initiating prepaid charging for the call comprises:
determining a rating for the call; and
granting a quota based on the rating.

14. The method of claim 13 wherein initiating prepaid charging for the call further comprises:
generating a rated prepaid CDR after the call ends; and
storing the rated prepaid CDR.

15. The method of claim 10 wherein initiating postpaid charging for the call comprises:
allowing the call to be completed.

16. The method of claim 15 wherein initiating postpaid charging for the call further comprises:
generating an unrated postpaid CDR after the call ends in a prepaid charging system; and
storing the unrated postpaid CDR.

17. The method of claim 16 wherein initiating postpaid charging for the call further comprises:
retrieving the unrated postpaid CDR from the prepaid charging system using the postpaid charging system;
determining a rating for the call; and
generating a rated postpaid CDR from the unrated postpaid CDR.

18. A charging selection system of a communication network, the charging selection system comprising:
a database adapted to store predefined charging criteria; and
a processing system adapted to receive a query for the call from a switching system serving a subscriber placing a call wherein the subscriber has subscribed to hybrid prepaid/postpaid charging, process the charging criteria to determine whether the hybrid prepaid/postpaid charging for the call should be prepaid or postpaid, initiate prepaid charging for the call responsive to a determination of prepaid charging for the call based on the charging criteria, and initiate postpaid charging for the call responsive to a determination of postpaid charging for the call based on the charging criteria.

19. The charging selection system of claim 18 wherein:
the charging criteria is predefined by at least one of the subscriber or a service provider operating the communication network; and
the charging criteria comprises at least one of time of day, day of week, location of the subscriber, destination of the call, instructions from the subscriber, call type, content type, or balance threshold.

20. The charging selection system of claim 18 wherein the charging selection system is implemented in a prepaid charging system of the communication network.
